(19) United States
(12) Patent Application Publication
(10) Pub. No.: US 2011/0085035 A1
(43) Pub. Date: Apr. 14, 2011

(54) APPARATUS AND METHOD FOR PROTECTING PRIVACY INFORMATION OF SURVEILLANCE IMAGE

(75) Inventors: SuGil CHOI, Daejeon (KR); Geonwoo KIM, Daejeon (KR); Jong-Wook HAN, Daejeon (KR); Hyun sook CHO, Daejeon (KR); Jin Hee HAN, Daejeon (KR); Hong Il JU, Daejeon (KR); Moo Seop KIM, Daejeon (KR); Young Sae KIM, Daejeon (KR); Yong-Sung JEON, Daejeon (KR)

(73) Assignee: Electronics and Telecommunications Research Institute, Daejeon (KR)

(21) Appl. No.: 12/622,681

(22) Filed: Nov. 20, 2009

(30) Foreign Application Priority Data
Oct. 9, 2009 (KR) 10-2009-0096009

(51) Int. Cl. H04N 7/18; H04N 11/02; G06K 9/36; G06K 9/34; H04L 9/14

(52) U.S. Cl. 348/143; 375/240.16; 382/283; 382/164; 348/E07.085; 375/E07.123; 380/45

(57) ABSTRACT

An apparatus for protecting privacy information of a surveillance image includes a key management unit for generating and managing keys used to unmask a masked input image; an input image processing unit for unmasking the input image using the keys, decoding the unmasked input image to acquire an uncompressed image data, and then applying a second masking on an area containing privacy information of the image data. Further, the apparatus for protecting the privacy information of the surveillance image includes an image recording unit for encoding the image data to which the second masking has been applied to store the encoded image data.

### CROSS-REFERENCE TO RELATED APPLICATIONS

The present invention claims priority of Korean Patent Application No. 10-2009-0096009, filed on Oct. 9, 2009, which is incorporated herein by reference.

### FIELD OF THE INVENTION

The present invention relates to an image processing method for a surveillance image; and more particularly, to an apparatus and method for protecting privacy information of a surveillance image, which is capable of solving the problem of privacy invasion resulting from the exposure of privacy-related information, such as a personal face, in case where a security control center monitors an image transmitted from a surveillance camera.

### BACKGROUND OF THE INVENTION

As a recent method for solving the problem of privacy invasion resulting from the exposure of privacy-related information, such as a personal face, in the case of monitoring an image transmitted from a surveillance camera, there is generally used a method for concealing a preset specific area or a specific area detected by image recognition from an image before the image is transmitted from a surveillance camera.

Such a method is referred to as privacy masking, which enables privacy-sensitive information to be masked when a security control center or the like reproduces the thus-transmitted image, thereby solving the problem of privacy invasion.

However, when masking an image encoded using the latest video encoding standards, privacy information can be masked but other image information may be damaged.

That is, because currently available IP cameras have video codecs pre-installed therein, it is difficult to add a masking function to the pre-installed codecs and it is practically impossible to add the masking function to each codec and thus masking is applied to an encoded bit stream. However, for a bit stream encoded by H.264 or MPEG4, which are the latest video encoding standards, even if only a portion corresponding to a masking area is changed, decoding leads to the distortion of the images of areas other than the selected area. This is because the latest video codecs tend to encode each data not independently but by cross-reference to increase compression rate.

In addition, the reason why not an entire image is encoded but only a privacy-sensitive portion is masked is to make non-privacy-sensitive information of the image available while providing privacy protection. If the image of an unintended portion appears to be broken, this will not be suitable for the original purpose of masking. For instance, when an image surveillance system is configured to mask a face of pedestrian and allow the control center to view other information to recognize the occurrence of a crime or other incidents, even though only a specific area is encoded, other image information is damaged due to the characteristics of the latest video codecs. This makes it difficult to get necessary information.

As mentioned above, the conventional techniques of protecting privacy information of a surveillance image include a method for adding a masking function to a pre-installed camera and a method for performing masking using a bit stream encoded by the video codec. In these conventional methods, however, problems, such as damage of the images of areas other than a masking area when performing masking, have not been considered. Consequently, when a general privacy masking method is employed, the images of the areas other than the masking area are damaged, thus making it difficult to attain the effects of incident detection and prevention, which is the original purpose of image surveillance.

### SUMMARY OF THE INVENTION

In view of the above, the present invention provides an apparatus and method for protecting privacy information of a surveillance image, which is capable of fulfilling the original purpose of image surveillance while solving the problem of privacy invasion in an image surveillance system.

That is, the present invention provides a technique in which a masked image is transmitted from a surveillance camera, the masked image is unmasked and decoded, and an area containing privacy information is masked from a resultant image and then provided. In other words, the masking performed by an image control server of the present invention is applied to uncompressed image data, which is functionally different from the masking in the surveillance camera. In addition, masking area information transmitted from the surveillance camera is not used as it is, but a more accurate area is calculated and used as the masking area information, thereby fulfilling the original purpose of image surveillance and also efficiently protecting privacy information.

Further, the present invention provides a hardware key management system, a key derivation method for making it difficult to infer the previous key, and a method for efficiently encoding image data masked by the image control server to overcome a security weakness which may appear as a weakness in the above-stated technical configuration.

In accordance with a first aspect of the present invention, there is provided an apparatus for protecting privacy information of a surveillance image, including: a key management unit for generating and managing keys used to unmask a masked input image; an input image processing unit for unmasking the input image using the keys, decoding the unmasked input image to acquire an uncompressed image data, and then applying a second masking on an area containing privacy information of the image data; and an image recording unit for encoding the image data to which the second masking has been applied to store the encoded image data.

In accordance with a second aspect of the present invention, there is provided a method for protecting privacy information, including: acquiring information of a masking area from an input image; unmasking the masked area of the input image using the information of the masking area; acquiring an uncompressed image data by decoding the unmasked input image; reconfiguring a second masking area containing privacy information of the image data; and performing masking on an image of the second masking area.

In the method for protecting privacy information of a surveillance image in accordance with the present invention, which is capable of solving the problem of privacy invasion resulting from the exposure of privacy-related information such as a personal face, when a security control center monitors an image transmitted from a surveillance camera, masking is performed on an image containing privacy information such as a personal face or the like, by changing the color of a corresponding area into a given color before providing a user with the image collected from the surveillance camera or the like, thereby efficiently protecting the privacy information while monitoring the surveillance image. Further, an encoding method used for an original surveillance image is applied when re-encoding the image which the privacy information is masked, thereby improving encoding speed.

### BRIEF DESCRIPTION OF THE DRAWINGS

The objects and features of the present invention will become apparent from the following description of embodiments, given in conjunction with the accompanying drawings, in which:

FIG. 1 shows a detailed block diagram of a privacy information protection apparatus of a surveillance image in accordance with an embodiment of the present invention;

FIG. 2 illustrates a flowchart of image processing for privacy information protection in an image control server in accordance with the embodiment of the present invention;

FIG. 3 offers a control flowchart for a masking area reconfiguration operation in accordance with the embodiment of the present invention; and

FIG. 4 depicts a control flowchart for an encoding operation in accordance with the embodiment of the present invention.

### DETAILED DESCRIPTION OF THE EMBODIMENTS

Hereinafter, embodiments of the present invention will be described in detail with the accompanying drawings which form a part hereof.

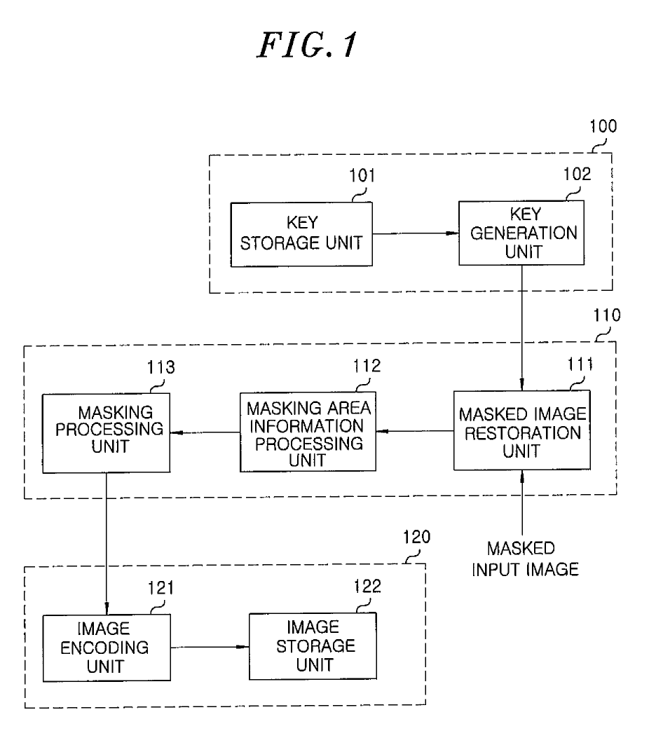

FIG. 1 shows a detailed block diagram of a privacy information protection apparatus of an image control server in accordance with an embodiment of the present invention. The privacy information protection apparatus includes a key management unit 100, an input image processing unit 110 and an image recording unit 120.

Hereinafter, the operation of each component of the privacy information protection apparatus of the present invention will be described in detail with reference to FIG. 1.

First, the key management unit 100 includes a key storage unit 101 and a key generation unit 102, and generates keys required to unmask a masked input image from an image input device, such as a surveillance camera, and manages the keys safely.

The biggest problem in performing the above unmasking procedure is security weakening caused by a temporary unmasked state. This is because an image, being unmasked and exposing privacy information, is present in the memory even for a little while, and the keys used for the unmasking is to be loaded onto the system. Thus, it is necessary to safely manage the keys used for the unmasking.

The keys used for the unmasking can be classified into a primary key (main key or long-term key) and secondary keys derived from the primary key. If the primary key always exists in the system memory, this increases the risk of key leakage.

Thus, the primary key is kept in a separate hardware device, and only the secondary keys derived from the primary key are made available outside the device. In this manner, the key storage unit 101 safely keeps the primary key and stores the secondary keys derived therefrom.

Meanwhile, if a number of frames of an input image masked by the secondary keys can be unmasked by only a single secondary key, leakage of one secondary key may affect several frames. Therefore, the key generation unit 102 receives a secondary key from the key storage unit 101 when unmasking, and then derives a different secondary key from the secondary key for each frame of the masked input image and uses the same. For instance, after using the secondary key in one frame, if a different secondary key, generated by hashing the secondary key through a hash function, is used in the next frame, the secondary key used in the previous frame cannot be found. Accordingly, even if one secondary key is leaked out, masked information of the previous frame cannot be decrypted, thereby reducing the risks resulting from key leakage.

The input image processing unit 110 includes a masked image restoration unit 111, a masking area information processing unit 112 and a masking processing unit 113. If a masked image is received from the surveillance camera, the masked image is unmasked by using keys provided from the key management unit 100 and decoded, and then a masking area is calculated more precisely with respect to an area containing privacy information of the decoded image data, followed by being subject to masking.

The masked image restoration unit 111 receives a masked input image from the surveillance camera or the like, loads the same on the memory in units of frames, and extracts masking area information from the image information loaded onto the memory and stores it separately.

Here, in order for the masked image restoration unit 111 to conduct the unmasking, information about which area of the input image is masked is required. This information may be received through a separate channel, or may be contained in a space in which user data defined in the video encoding standards can be added for transmission. Of the two, the latter method that enables this information to be contained in an encoded image is effective.

A masking area can be defined in various methods. That is, a masking area may be defined in pixel units in the same manner as an actual masking area, or may be defined in 4×4 or 8×8 blocks or in 16×16 macroblocks. If defined in pixel units, the masking area can be precisely represented but the number of bits for representing the masking area increases. On the other hand, if defined in units of 16×16 macro blocks, the number of required bits decreases but the masking area cannot be represented in detail. Since video encoding focuses on compression efficiency, it employs macroblock representation requiring a smaller number of bits.

Further, the masked image restoration unit 111 proceeds the masking procedure carried out in the surveillance camera in a reverse order to conduct the unmasking. To this end, the keys used for the masking and the masking area information are required. The required keys are input from the key generation unit 102, and the masking area information is extracted from the image information loaded in units of frames of the masked input image provided from the surveillance camera or the like as described above. After the unmasking is conducted in this way, image data encoded in the surveillance camera is obtained, and the encoded image data undergoes a decoding procedure which is paired with the encoding procedure, thereby acquiring image data to be displayed. Because the image data thus acquired is the data decoded after the unmasking and thus contains privacy-sensitive information, the image data needs not be provided as it is to an unauthorized person.

Therefore, a privacy-related area has to be masked before provision. The masking area information processing unit 112 reconfigures a masking area for a privacy-information-containing area in the image data restored by the masked image restoration unit 111 by taking the features of a masking target into account.

Here, when the masking area information processing unit 112 reconfigures the masking area, if masking area information is represented in macroblocks, the number of bits required for representation is decreased but there is a limitation in accurately representing an actual area. However, if it can be found out what the masking target is, it is possible to reconfigure a more accurate area from macroblock unit data based on the information on the masking target. If the masking area is defined more precisely, it is possible to minimize the masking of image information not related to privacy, thereby maximizing the extent of information that is made available through image surveillance.

The masking processing unit 113 performs an image processing for changing the colors of the pixels in the masking area reconfigured by the masking area information processing unit 112 into a given color so that privacy information can be protected. At this time, because a decoded image includes pixels, only the values of the pixels corresponding to the masking area are changed and which color the pixels have is not specifically determined. The image thus masked can be provided to the unauthorized person without risk of privacy invasion.

The image recording unit 120 includes an image encoding unit 121 and an image storage unit 122, re-encodes and stores uncompressed image data in which an area containing privacy information is masked, applied from the input image processing unit 110. During encoding, the information encoded in the surveillance camera is reused to thereby efficiently perform encoding.

When receiving the masked image data, the image encoding unit 121 determines whether the encoding method of the input image provided from the surveillance camera, which is the original image of the image data, is an intra prediction method or an inter prediction method, and encodes the image data depending on the determined encoding method to thus increase encoding efficiency.

That is, if the encoding method of the input image provided from the surveillance camera is the intra prediction method, the image encoding unit 121 performs encoding on all the macroblocks before the reconfigured masking area of the image data by duplicating the encoding result values of the input image as it is, and performs encoding on all the macroblocks after the reconfigured masking area by reusing an intra prediction mode included in the input image. On the other hand, if the encoding method of the input image provided from the surveillance camera is the inter prediction method, the image encoding unit 121 performs encoding on the macroblocks, which do not refer to the reconfigured masking area, among the macroblocks before the reconfigured masking area of the image data by duplicating the encoding result values of the input image as it is. Further, the image encoding unit 121 performs encoding on the macroblocks after the reconfigured masking area by reusing the motion vector included in the input image.

The image storage unit 122 stores the image data encoded by the image encoding unit 121 and provides a privacy-masked image when an image reproduction is requested by a user.

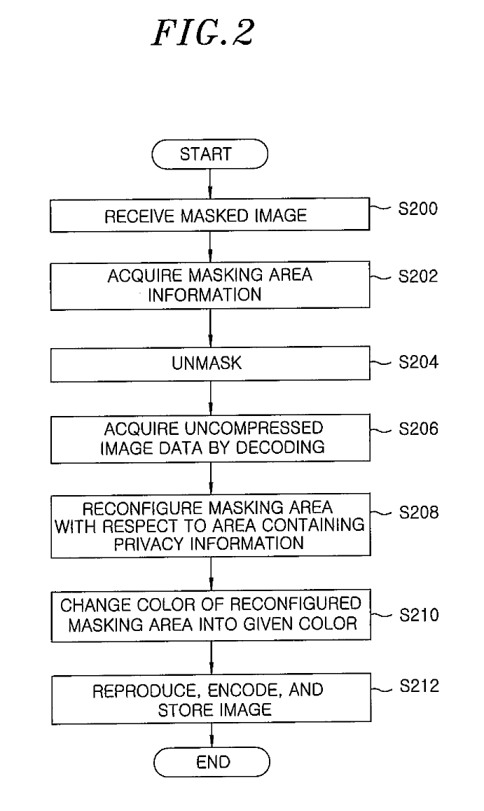

FIG. 2 shows a flow chart of image processing for generating a masked input image as a privacy protected image in the privacy information protection apparatus in accordance with an embodiment of the present invention. Hereinafter, the embodiment of the present invention will be described in detail with reference to FIGS. 1 and 2.

First, when a masked image is input from an image input device such as a surveillance camera, the masked image restoration unit 111 receives the masked input image in step S200, loads image information to a memory in units of frames, and acquires masking area information from the image information loaded on the memory to store the masking area information separately in step S202.

Next, in step S204, the masked image restoration unit 111 receives the masking area information acquired in step S202 and the keys required for unmasking from the key generation unit 102, and performs the unmasking of the masked input image.

As described above, if the masked input image is unmasked, image data encoded in the surveillance camera or the like is obtained. The masked image restoration unit 111 performs a decoding procedure, which is paired with the encoding procedure in the surveillance camera, on the image data, thereby acquiring uncompressed image data in step S206.

Here, the thus acquired image data is the data decoded after the unmasking and therefore contains privacy-sensitive information such as the image of a personal face. Thus, the image data needs not be provided as it is to an unauthorized person.

Accordingly, the masking area information processing unit 112 reconfigures a masking area with respect to an area containing privacy information in the uncompressed image data restored by the masked image restoration unit 111 to perform masking to the masking area again in step S208.

At this point, when reconfiguring the masking area, if the masking area information is represented in macroblocks, the number of bits required for representation is decreased but there is a limitation in accurately representing an actual area. However, if it can be found out what the masking target is, it is possible to reconfigure a more accurate area from macroblock unit data by using the information of the masking target. That is, if a masking area is defined more precisely, it is possible to minimize the masking of image information not related to privacy, thereby maximizing the extent of information that is made available through image surveillance.

As described above, when the masking area with respect to the area containing the privacy information is reconfigured by the masking area information processing unit 112, masking area reconfiguration information is applied to the masking processing unit 113.

Then, in step S210, the masking processing unit 113 performs an image processing for changing the colors of the pixels, which are included in the reconfigured masking area containing the privacy information in the uncompressed image data restored by the masked image restoration unit 111, into a given color by using the masking area reconfiguration information, so that the privacy information can be removed. Next, in step S212, the image encoding unit 121 performs image reproduction and encoding on the image data on which the masking procedure has been applied, and stores it in the image storage unit 122.

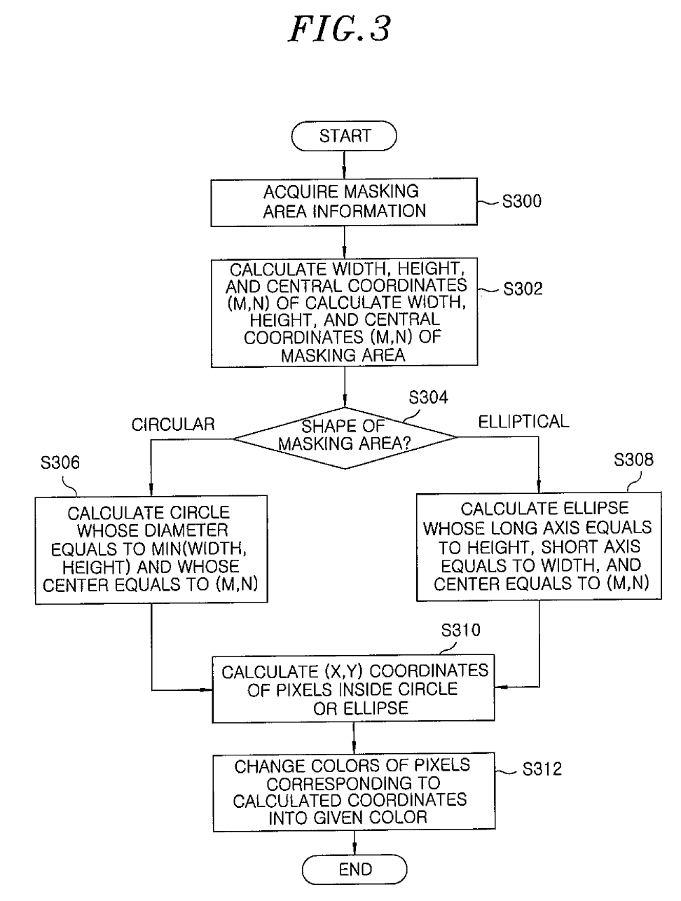

FIG. 3 is a control flow chart for an operation for reconfiguring the masking area containing the privacy information—for the restored (or unmasked) image data by the masking area information processing unit 112 in accordance with an embodiment of the present invention. Hereinafter, the embodiment of the present invention will be described in detail with reference to FIGS. 1 and 3.

First, in step S300, the masking area information processing unit 112 acquires masking area information defined in the macroblocks with respect to the area containing privacy information of uncompressed image data restored by the masked image restoration unit 111.

Next, the masking area information processing unit 112 calculates the height of the masking area at the uppermost and lowermost macroblocks among the macroblocks included in the masking area, and calculates the width of the masking area at the leftmost and rightmost macroblocks. Then, the masking area information processing unit 112 calculates the center coordinates of these macroblocks in step S302.

Here, if the masking target is a personal face, it can be represented nicely as an ellipse or circle. The masking area calculation procedure is varied depending on in what shape the masking area is represented.

Therefore, in step S304, the masking area information processing unit 112 determines in what shape the masking area is represented based on the width, height, and center coordinate information of the masking area calculated in step S302.

At this time, when the masking area is represented in the shape of a circle, in step S306, the masking area information processing unit 112 finds an equation of a circle of which the diameter is the shortest among the center coordinates, width, and height of the masking area calculated in step S302, and sets the masking area.

On the other hand, when the masking area is represented in the shape of an ellipse, in step S308, the masking area information processing unit 112 finds an equation of an ellipse of which the long axis is the vertical direction of the masking area and of which the short axis is the horizontal direction thereof based on the information of the center coordinates, width, and height of the masking area calculated in step S302, and sets the masking area.

When the equation for representing the masking area is obtained in this way, the masking area information processing unit 112 can calculate the coordinates of the pixels present in each masking area in step S310. Therefore, the masking processing unit 113 can mask information corresponding to privacy of image by changing the values of the pixels in the masking area into a given color by using the masking area information established by the masking area information processing unit 112 in step S312.

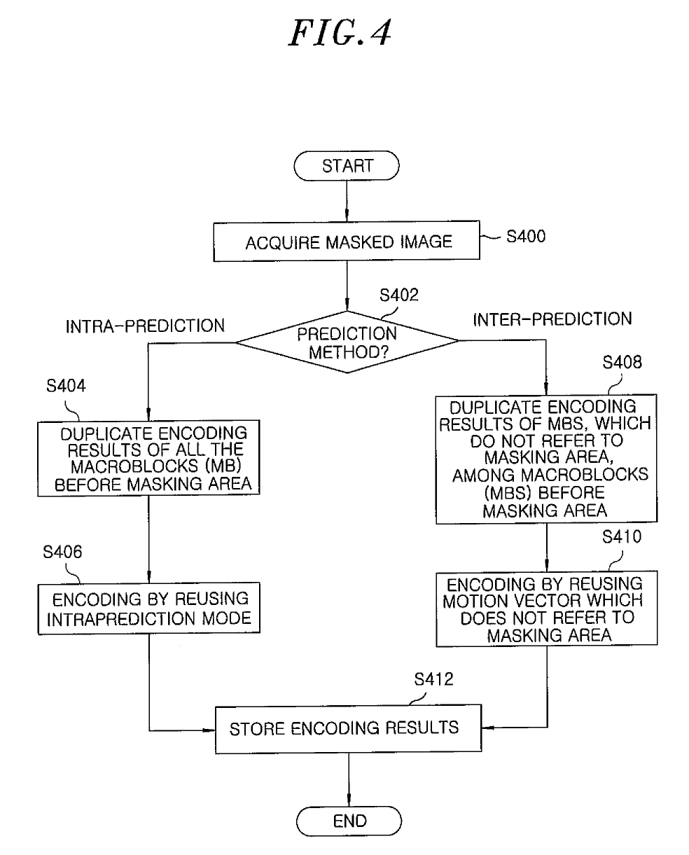

FIG. 4 shows a control flow chart for an operation for efficiently re-encoding a masked image by the image encoding unit 121 in accordance with an embodiment of the present invention. Hereinafter, the embodiment of the present invention will be described in detail with reference to FIGS. 1 and 4.

Because video encoding is a very complex procedure, a lot of system resources are used. Thus, if the system simultaneously performs several encodings, which may deteriorates system performance. Therefore, a method for performance enhancement is required when encoding an image masked in the image control server. The method can be easily achieved by using encoded image information transmitted from the surveillance camera.

First, the image encoding unit 121 acquires masked and uncompressed image data applied from the masking processing unit 113 in step S400, and determines which method is to be used to encode the frames corresponding to the image between inter prediction and intra prediction in step S402.

The encoding method is determined depending on which method has been used to encode the input image transmitted from the surveillance camera. Hereinafter, a description will be given under the assumption that the video codecs used for the surveillance camera can perform both intra prediction and inter prediction.

If the encoding method used for the surveillance camera is the intra prediction method, encoding may not be performed on all the macroblocks before the macroblock where the reconfigured masking area exists. Therefore, in step S404, the image encoding unit 121 performs encoding on all the macroblocks before the reconfigured masking area of the image data applied from the masking processing unit 113 by duplicating the encoding result values of the input image as it is. Here, the more the masking area is positioned in the right and lower sides of the image, the greater the improvement in performance induced by the reuse of the encoding result of the macroblocks.

Next, the image encoding unit 121 determines the intra prediction mode for the macroblocks after the reconfigured masking area and performs intra coding thereon. When performing the intra coding, the determination of the intra prediction mode requires the longest calculation time. At this point, there is a very high likelihood that the encoding result of the macroblocks existing after the reconfigured masking area will match the result of calculation of the intra prediction mode encoded and transmitted by the surveillance camera. Thus, there is no need for re-calculation, but the intra prediction mode can be fetched for use as it is from the encoding result transmitted by the surveillance camera.

Accordingly, in step S406, the image encoding unit 121 performs the encoding on the macroblocks after the reconfigured masking area by reusing the intra prediction mode, contained in the input image encoded and transmitted by the surveillance camera.

On the other hand, if the encoding method used for the surveillance camera is the inter prediction method, in step S408, the image encoding unit 121 performs the encoding on the macroblocks, which do not refer to the reconfigured masking area, among the macroblocks before the reconfigured masking area of the image data applied from the masking processing unit 113 by duplicating the encoding result values of the input image as it is.

In the inter prediction method, unlike the intra prediction, even a macroblock before the reconfigured masking area cannot be used as it is if the motion vector of the corresponding macroblock refers to masked macroblocks of the previous frame. Therefore, the encoding result of the macroblocks before the macroblock which exists in the masking area is duplicated from the encoding result transmitted from the surveillance camera, except for the case where the corresponding motion vector refers to the masked macroblocks of the previous frame.

Next, the image encoding unit 121 performs encoding for the macroblocks after the reconfigured masking area by calculating the motion vector by inter prediction. The calculation of the motion vector by inter prediction requires the longest time at the time of inter ceding, and affects most on performance in the entire video encoding procedure.

Although a motion vector for referring to the reconfigured masking area changed into a given color needs re-calculation, image information on areas except for the reconfigured masking area is identical to that at the time of encoding by the surveillance camera. Thus, the image encoding unit 121 performs encoding on the macroblocks except for the reconfigured masking area by reusing the motion vector included in the input image encoded and transmitted by the surveillance camera in step S410.

Next, the image storage unit 122 stores the thus-encoded image in step S412 so that the privacy-masked image can be viewed without a series of processes described in FIG. 2 when a reproduction of the corresponding image is required later.

While the invention has been shown and described with respect to the embodiments, it will be understood by those skilled in the art that various changes and modification may be made without departing from the scope of the invention in the following claims.

What is claimed is:

1. An apparatus for protecting privacy information of a surveillance image, comprising:
a key management unit for generating and managing keys used to unmask a masked input image;
an input image processing unit for unmasking the input image using the keys, decoding the unmasked input image to acquire an uncompressed image data, and then applying a second masking on an area containing privacy information of the image data; and
an image recording unit for encoding the image data to which the second masking has been applied to store the encoded image data.

2. The apparatus of claim 1, wherein the key management unit includes:
a key storage unit for storing a primary key used to unmask the input image and secondary keys derived from the primary key; and
a key generation unit for generating a different secondary key derived from the secondary key for each frame of the input image when unmasking the input image to provide the different secondary key.

3. The apparatus of claim 2, wherein the key generation unit generates a different secondary key from the secondary key for each frame of the input image by using a hash function.

4. The apparatus of claim 1, wherein the input image processing unit includes:
a masked image restoration unit for unmasking the masked input image using the keys and decoding the unmasked input image to restore the uncompressed image data;
a masking area information processing unit for detecting the area containing the privacy information of the image data to reconfigure the area containing the privacy information as a second masking area; and
a masking processing unit for performing masking on the reconfigured second masking area of the image data.

5. The apparatus of claim 4, wherein the masked image restoration unit receives the masked input image and loads image information to a memory in units of frames, and extracts information of a masking area from the loaded image information.

6. The apparatus of claim 4, wherein the masking area information processing unit acquires information of the second masking area defined in macroblocks containing privacy information, from the image data, calculates the width, height, and central coordinates of the second masking area to determine the shape of the second masking area as a circle or ellipse, and then calculates the coordinates of pixels present inside the circle or ellipse to reconfigure the second masking area.

7. The apparatus of claim 4, wherein the masking processing unit performs masking by image processing for changing the color of each pixel present in the second masking area into a given color.

8. The apparatus of claim 1, wherein the image recording unit includes:
an image encoding unit for encoding the image data to which the second masking is applied; and
an image storage unit for storing the encoded image data.

9. The apparatus of claim 8, wherein, after acquiring the image data to which the second masking is applied, the image encoding unit determines the encoding method of the input image, and if the encoding method of the input image is an intra prediction method, the image encoding unit performs encoding on all the macroblocks before the second masking area of the image data by duplicating the encoding result values of the input image as it is, and performs encoding on all the macroblocks after the second masking area by reusing an intra prediction mode included in the input image.

10. The apparatus of claim 9, wherein, if the encoding method of the input image is an interprediction method, the image encoding unit performs encoding on the macroblocks not referring to the second masking area, among the macroblocks before the second masking area of the image data by duplicating the encoding result values of the input image as it is, and performs encoding on the macroblocks after the second masking area by reusing the motion vector included in the input image.

11. A method for protecting privacy information, comprising:
acquiring information of a masking area from an input image;
unmasking the masked area of the input image using the information of the masking area;
acquiring an uncompressed image data by decoding the unmasked input image;
reconfiguring a second masking area containing privacy information of the image data; and
performing masking on an image of the second masking area.

12. The method of claim 11, wherein said unmasking the masked area unmasks the masked image by generating the same keys as keys used when masking the input image.

13. The method of claim 12, wherein the keys are classified into a primary key and secondary keys derived from the primary key, and the input image is unmasked by using the secondary keys.

14. The method of claim 13, wherein a different secondary key is generated from the secondary key for each frame of the input image and used for the unmasking.

15. The method of claim 14, wherein the different secondary key is generated from the secondary key using a hash function.

16. The method of claim 11, wherein said reconfiguring the second masking area includes:
acquiring information of the second masking area defined in macroblocks containing privacy information, from the image data;
calculating the width, height, and central coordinates of the second masking area to determine the shape of the second masking area as a circle or ellipse based on the acquired information; and
calculating the coordinates of pixels present inside the circle or ellipse.

17. The method of claim 11, wherein said applying masking performs masking by image processing for changing the color of each pixel in the second masking area into a given color.

18. The method of claim 11, further comprising:
encoding the image data to which the second masking is performed; and
storing the encoded image data.

19. The method of claim 18, wherein said encoding the image data includes:
acquiring image data to which the second masking is performed;
determining the encoding method of the input image;
if the determined encoding method of the input image is an intra prediction method, performing encoding on all the macroblocks before the second masking area of the image data by duplicating the encoding result values of the input image as it is; and
performing encoding on all the macroblocks after the second masking area by reusing an intra prediction mode included in the input image.

20. The method of claim 19, wherein said encoding the image data further includes:
if the determined encoding method of the input image is an inter prediction method, performing encoding on the macroblocks not referring to the second masking area, among the macroblocks before the second masking area of the image data by duplicating the encoding result values of the input image as it is; and
performing encoding on the macroblocks after the second masking area by reusing the motion vector included in the input image.
